(19) United States
(12) Patent Application Publication
(10) Pub. No.: US 2009/0174527 A1
(43) Pub. Date: Jul. 9, 2009

(54) SURFACE MOUNT CAPACITOR USED AS A SUBSTRATE FLIP-CHIP CARRIER IN A RADIO FREQUENCY IDENTIFICATION TAG

(76) Inventor: Robert Stewart, Boulder, CO (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/351,520

(22) Filed: Jan. 9, 2009

Related U.S. Application Data
(60) Provisional application No. 61/019,906, filed on Jan. 9, 2008.

(51) Int. Cl. H04Q 5/22

(52) U.S. Cl. 340/10.1

(57) ABSTRACT

In a passive radio frequency identification (RFID) transponder comprising an integrated circuit, an antenna coil, and at least one surface mount capacitor, a configuration is disclosed in which the surface mount capacitor is used as the integrated circuit carrier. The integrated circuit comprises a bumped die flip-chip, and the surface mount capacitor substrate has electrically conductive contacts and connections for electrically joining the antenna coil, capacitor, and integrated circuit. Transponders in accordance with embodiments of the invention do not include an intermediate substrate carrier onto which the capacitor and integrated circuit are mounted and interconnected, and to which the antenna coil is subsequently attached.

### CROSS REFERENCE TO RELATED APPLICATIONS

This application claims priority to U.S. Provisional Application Ser. No. 61/019,906 filed Jan. 9, 2008, the entirety of which is incorporated herein by reference.

### FIELD OF THE INVENTION

The present invention relates to radio frequency identification (RFID) systems, and in particular to passive RFID transponders (frequently referred to as tags), into which identification information is embedded. Conventionally, such passive RFID tags operate in conjunction with a scanner device, which emits a magnetic field that couples with the RFID tag, providing it activation power, and providing a means of identification information conveyance. Passive RFID tags conventionally comprise an antenna coil, and integrated circuit, and one or more capacitors.

### BACKGROUND

Passive low frequency RFID scanners and tags use operating principles that are well-known to those of ordinary skill in the art, and that are described in extensive detail in several seminal inventions, including U.S. Pat. No. 1,744,036 to Brard (1930), U.S. Pat. No. 3,299,424 to Vinding (1967), U.S. Pat. No. 3,713,148 to Cardullo et al. (1973), and U.S. Pat. No. 5,053,774 to Schuermann et al. (1991), and in textbooks such as RFID Handbook (Finkenzeller—1999).

In RFID systems of this type, the scanner (also sometimes referred to as a reader or interrogator) device generates a tag activation signal, and receives identification data signals from the RFID tag. As depicted in FIG. 1, the scanner comprises electronic circuitry, which generates an activation signal (usually a single frequency unmodulated signal) using a signal source 101 and an amplifier 102 to drive a resonant antenna circuit 103. This activation signal is manifested as a time-varying electromagnetic field, which couples with the RFID tag 105 by means of the electromagnetic field's magnetic field component 104. The RFID tag 105 converts this magnetic field into an electrical voltage and current, and uses this electrical power to activate its internal electronic circuitry. Using any of several possible modulation schemes, the RFID tag conveys binary encoded information stored within it back to the scanner via magnetic field 104, where the detector and utilization circuit 106 converts this binary code into an alphanumeric format tag data 107 in accordance with some prescribed application.

There are generally considered to be two types of passive transponder technologies, which are designated full duplex (FDX) and half-duplex (HDX). In the described manners that follow for FDX and HDX transponders, activation energy is transferred to the transponder from the scanner, and identification code information is transferred to the scanner from the transponder through the mutual coupling of a magnetic field.

The FDX transponder amplitude modulates the scanner's activation signal with its binary identification code sequence. The scanner detects this modulation and derives from it the FDX transponder's identification code. The term full-duplex is indicative that the FDX transponder sends its identification code information during the time when it is receiving the activation signal from the scanner.

In contrast, the HDX transponder uses the scanner's activation signal to charge an internal capacitor (which functions as a very small rechargeable battery), and it uses this stored energy to self-activate a transmitter, which emits a frequency shift keyed (FSK) signal representative of the transponder's identification code. The scanner detects this FSK signal and derives from it the HDX transponder's identification code. The term half-duplex is indicative that the scanner and the HDX transponder exchange the activation signal and the identification code signal in alternating time intervals.

Contemporary RFID tags comprise a single integrated circuit, or chip, that is electrically connected to a resonant circuit, which comprises an antenna coil and resonant capacitor. Together, the coil and capacitor resonate at a prescribed radio frequency, such as 134.2 KHz, and efficiently couple the activation signal to the tag, and the identification signal back to the scanner. The evolution of integrated circuit technology has enabled the fabrication of RFID transponder chips whose physical dimensions are as small as 1 mil² (1 mil=one-thousandth of one meter, one millimeter, or 10⁻³ meter). Chips as small as this create the possibility of transponders with extremely small form factors.

An FDX transponder comprises an integrated circuit chip, an antenna coil, and a resonant capacitor. In a number of FDX transponder designs, the resonant capacitor can be advantageously fabricated as a component within the integrated circuit, thus reducing the assembly components to the integrated circuit chip and the antenna coil. U.S. Pat. No. 5,281,855 discloses such a two component assembly wherein the antenna coil leads are directly attached to bonding pads on the integrated circuit, thus resulting in an efficient and economical RFID tag.

An HDX transponder comprises the same three components as the FDX transponder, but in addition requires one additional capacitor component used to store energy received from the scanner's activation signal. The size of the capacitor required to store a sufficient amount of energy for tag operation currently prohibits its fabrication within the integrated circuit, and so this charge capacitor remains a discrete component in conventional HDX transponders. Consequently, an HDX transponder comprises four assembly components (an integrated circuit, a coil, a resonant capacitor, and a charge capacitor) and is more complex than the aforementioned FDX transponder assembly.

As with the FDX transponder, the resonant capacitor component can be fabricated within the HDX integrated circuit. This, however, still leaves the charge capacitor as a discrete component. Even if the coil is directly bonded to the HDX integrated circuit as disclosed in U.S. Pat. No. 5,281,855, the assembly must accommodate the physical and electrical attachment of the charge capacitor. U.S. Pat. No. 5,729,053, for example, discloses a mechanical substrate onto which the capacitor and integrated circuit are mounted, and then which are interconnected to each other and to a coil using wire bonding. In yet another configuration, U.S. Pat. No. 6,947,004 discloses a transponder construction comprising an antenna coil with a ferrite core. The coil is wound around the ferrite core, and the core extends beyond the coil at one end and has a flattened surface onto which two metal contacts are deposited on top of an insulating layer. These two metal contacts are used for electrically connecting the antenna coil leads, the integrated circuit, and the capacitor. However, not all transponder antenna coils are fabricated on ferrite cores. Many transponders, in fact, use an air-core antenna, comprising simply multiple turns of small diameter copper wire wound in a circular geometry. The coil by itself has no surface on which conductive contacts can be deposited for use in mounting and attaching the integrated circuit and capacitor.

The ability to construct a two component FDX transponder assembly has meant that FDX transponders, such as the Zoodiac tag manufactured by Sokymat S.A. of Switzerland can be constructed having dimensions in the order of a 12 mm in length and a diameter of 2.1 mm. By contrast, the requirement that an HDX transponder assembly include an external capacitor results in HDX transponders being considerably larger. A typical small HDX transponder has a length of the order of 23 mm and a diameter in the order of 3.85 mm (see for example part number RI-TRP-REHP manufactured by Texas Instruments, Inc. of Dallas, Tex.).

### SUMMARY OF THE INVENTION

Transponders in accordance with embodiments of the present invention use a charge capacitor as a mounting substrate on which an electrically conductive circuit is deposited and to which an integrated circuit is directly attached using flip-chip assembly techniques. Antenna coil leads are also attached at contact points to the circuits on the surface of the capacitor. Constructing a transponder in accordance with an embodiment of the invention eliminates the need for a separate substrate within the transponder assembly and enables the construction of transponders such as HDX transponders with smaller form factors. In addition, production efficiency can be increased due to the elimination of the manufacturing steps involved in attaching the integrated circuit and capacitor to the substrate, and attaching a substrate subassembly to the coil prior to attaching the coil leads.

One embodiment of the invention includes a capacitor having at least two terminals, where circuit traces are formed on at least one surface of the capacitor and connect to the terminals, an integrated circuit mounted to a surface of the capacitor and including a plurality of contacts connected to the circuit traces formed on the capacitor, and an antenna coil including two antenna leads that are connected at contact points to the circuit traces formed on the capacitor. In addition, the circuit traces connect at least two of the terminals of the capacitor to at least two of the contacts of the integrated circuit, the circuit traces connect the two antenna leads to at least two of the contacts of the integrated circuit, and the integrated circuit includes circuitry capable of generating an identification code signal in response to receipt of an activation signal by via the antenna coil.

In a further embodiment, the capacitor includes a ceramic layer and the circuit traces are formed on the surface of the ceramic layer.

In another embodiment, the integrated circuit is mounted to the surface of the ceramic layer of the capacitor.

In a still further embodiment, the capacitor is a Multi-Layer Chip Capacitor.

In still another embodiment, the circuitry of the integrated circuit includes an integrated resonant capacitor.

In a yet further embodiment, a resonant capacitor including two contacts mounted to the surface of said capacitor, where the terminals of the resonant capacitor are connected to the circuit traces formed on said capacitor. In addition, the circuit traces connect the resonant capacitor in parallel with the antenna leads.

In yet another embodiment, the circuit traces formed on at least one surface of the capacitor are patterns of electrically conductive material formed directly on the surface of the capacitor.

In a further embodiment again, the circuit traces formed on at least one surface of the capacitor further include an intermediate film substrate on which patterns of electrically conductive material are formed, where the intermediate film substrate is bonded to at least one surface of the capacitor.

In another embodiment again, the contacts of the integrated circuit are bumped contacts.

A further additional embodiment includes an encapsulant that encapsulates the integrated circuit and bonds the integrated circuit to the capacitor.

In another additional embodiment, the capacitor is a two element capacitor that includes a charge capacitor having two terminals and a tuning capacitor having two terminals manufactured in a monolithic package.

A still yet further embodiment includes forming circuit traces on a ceramic surface of a capacitor, aligning an integrated circuit including contacts with respect to the circuit traces formed on the ceramic surface, and mounting the integrated circuit to the ceramic surface of the capacitor.

In still yet another embodiment, the capacitor is a multi-layer chip capacitor and the circuits are screened onto the ceramic surface of the capacitor using thick film processing techniques.

In a still further embodiment again, the integrated circuit is a die that includes contact pads that is prepared for mounting to the ceramic surface of the capacitor by bumping the contacts of the integrated circuit.

In still another embodiment again, mounting the integrated circuit further comprises reflowing the bumps on the contacts of the integrated circuit.

A still further additional embodiment further includes dispensing an underfill adjacent the integrated circuit and curing the underfill.

Another additional embodiment includes forming circuit traces on a ceramic surface of a capacitor, aligning an integrated circuit including contacts with respect to the circuit traces formed on the ceramic surface, mounting the integrated circuit to the ceramic surface of the capacitor, and connecting antenna leads at contact points to the circuit traces formed on the surface of the capacitor.

Another further embodiment further includes encapsulating the capacitor, the integrated circuit and the antenna.

### BRIEF DESCRIPTION OF THE FIGURES

FIG. 1 illustrates the components and operating principles of an RFID system.

FIG. 2 illustrates in isometric view a typical surface mount capacitor and associated dimensions.

FIG. 3 illustrates in isometric view a transponder assembly in accordance with an embodiment of the present invention.

FIG. 4 illustrates a capacitor with the electrical contacts and conductive paths applied to its surface in accordance with an embodiment of the invention.

FIGS. 5(a)-5(c) illustrates three views of the assembled capacitor and integrated circuit in accordance with an embodiment of the present invention.

FIG. 6 illustrates the capacitor and integrated circuit assembly attached to an air-core coil in accordance with an embodiment of the present invention.

FIG. 7 illustrates in isometric view of a transponder including a capacitor on which an integrated circuit and a tuning capacitor are mounted in accordance with an embodiment of the present invention.

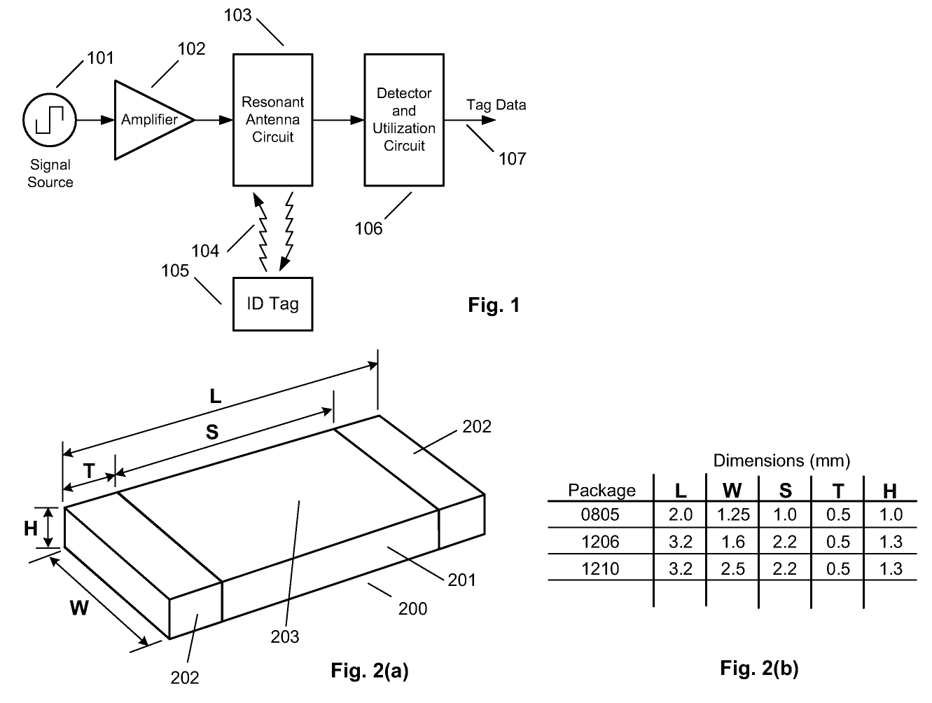

### DETAILED DESCRIPTION OF THE INVENTION

Turning now to the drawings, transponders and techniques for manufacturing transponders in accordance with embodiments of the invention are disclosed. In a number of embodiments, the transponders include a capacitor having circuit traces formed on its surface. An integrated circuit including transponder circuitry is mounted to the surface of the capacitor and is electrically connected to the capacitor via the circuit traces. An antenna is also fixed to the surface of the capacitor at contact points and is electrically connected to the integrated circuit via the circuit traces. In a number of embodiments, the capacitor is a Multi-Layer Chip Capacitor (MLCC) and the circuit traces are formed on the surface of the outermost ceramic layer of the capacitor. In several embodiments, the integrated circuit is mounted to a ceramic surface on the capacitor using a flip-chip mounting technique. In many embodiments, the circuit traces used to interconnect the MLCC and the integrated circuit are formed onto a ceramic surface of the MLCC using a process similar to the processes that are used in the manufacture of electric hybrid circuits. Processes in accordance with embodiments of the invention can be used to construct low frequency HDX RFID transponders with smaller form factors than conventional low frequency HDX RFID transponders including an intermediate substrate.

Surface mount capacitors used in accordance with embodiments of the present invention are frequently referred to as Multi-Layer Chip Capacitors (MLCC) that are constructed by sandwiching alternating layers of an electrically conductive electrode metal material and a dielectric insulating ceramic material. An isometric illustration of an MLCC is presented in FIG. 2(a). The MLCC 200 includes a small package having overall dimensions length L, width W, and height H. Physically, the MLCC has the sandwiched layers of ceramic and metal stacked along dimension H. Electrical terminations 202 connect with alternate metal layers, thus forming the capacitive element. The exterior surface 203 of the MLCC that lies between terminal contacts 202 is non-conductive ceramic. MLCCs are available from a variety of sources including Murata Manufacturing Co., Ltd of Kyoto, Japan.

Ceramic materials are used as substrates in a class of printed wiring boards known as electric hybrid circuits or hybrid circuits that are typically used in high temperature and/or high frequency applications. A hybrid circuit typically comprises a thin ceramic substrate that measures a few centimeters in length and width, on which conductive metal paths can be deposited and resistive ink applied. The metal paths are often deposited using thick film processes involving screen printing a conductive copper paste onto the substrate in a desired pattern and baking the substrate to form copper traces on the surface of the substrate. Alternately, other techniques can be used to form copper traces on the surface of a ceramic substrate. Electronic components can be soldered to deposited metal contacts, and resistors formed by the resistive ink. The ceramic substrate provides a thermally high stability substrate for the resistors, whose values can be precisely trimmed by laser or other etching processes. Such hybrid circuit assembly is useful for the manufacture of specialized functions that may be used in a multitude of higher-level electronic assemblies. Manufacturing processes in accordance with embodiments of the invention use the same processes that have been developed to form circuits on the ceramic substrates used in hybrid circuits to form circuits on the ceramic exterior of an MLCC. Consequently, the ceramic exterior of an MLCC can have electrically conductive paths and contacts applied to it and other electronic components can be surface mounted to the MLCC. The need for a separate substrate is eliminated, because the MLCC becomes the substrate.

FIG. 2(b) provides a table of dimensions for standard size MLCC packages. The package descriptions 0805, 1206, and 1210 are mnemonic references to the MLCC device physical dimensions in imperial units. Thus, the 0805 size package has length and width of 0.08 inches and 0.05 inches, respectively, which translates into metric dimensions 2.0 millimeters and 1.25 millimeters, respectively. The 1206 and 1210 size packages similarly translate into metric dimensions of 3.2 mm×1.6 mm and 3.2 mm×2.5 mm, respectively.

In FIG. 2(a), S designates one dimension of the non-conductive ceramic surface of the MLCC, and W designates its width. In the table in FIG. 2(b), the dimensions S and W are listed, and for the 0805, 1206, and 1210 size packages are 1.0 mm×1.25 mm, 2.2 mm×1.6 mm, and 2.2 mm×2.5 mm, respectively. Thus, all three package sizes have ceramic surfaces that are at least equal to or exceed the dimensions of a 1.0 mm×1.0 mm integrated circuit chip. Although specific standard dimensions are discussed above, a number of embodiments use custom (non-standard) size MLCCs to provide increased compatibility with a particular integrated circuit and/or manufacturing process.

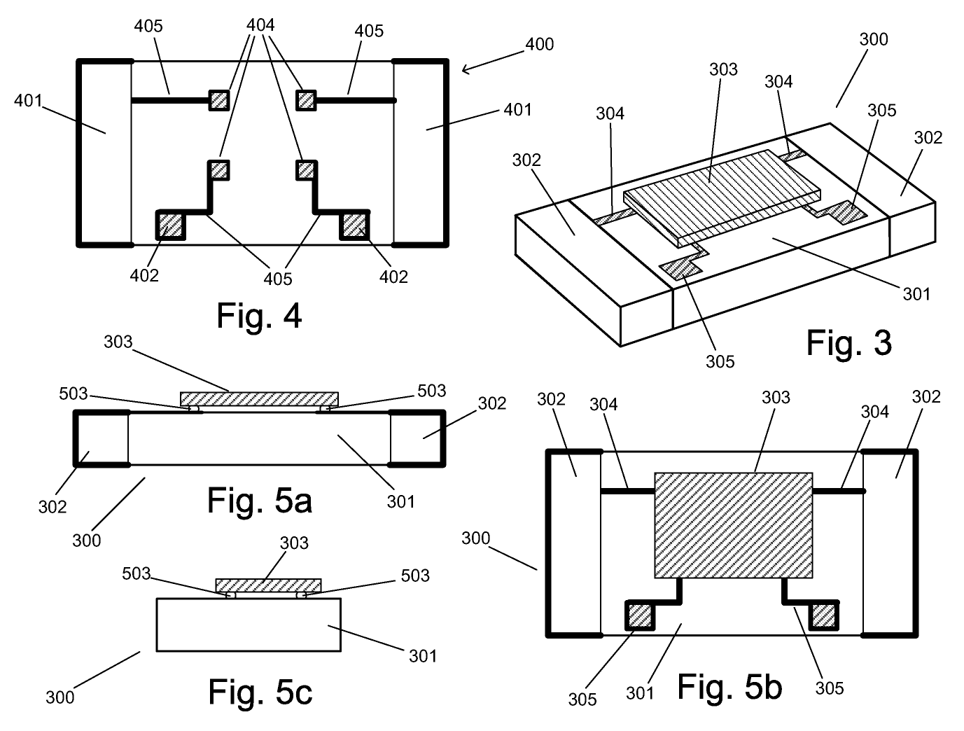

FIG. 3 illustrates a transponder assembly 300 in isometric view including an integrated circuit 303 mounted in flip-chip fashion on a MLCC 301 in accordance with an embodiment of the invention. Conductive paths 304 provide electrical connection between terminals on the integrated circuit (not shown) and the MLCC terminals 302. Connection points 305 are terminations for the antenna coil.

Flip chip mounting is also known as controlled collapse chip connection and is a method for interconnecting semiconductor devices to external circuitry with conductive bumps that are deposited onto pads on the semiconductor device. The conductive bumps are deposited on pads on the top surface of a semiconductor die during manufacturing and the die is flipped over so that its top side faces down, and aligned so that its pads align with matching pads on the external circuit. A bond is formed between the integrated circuit and the pads on the external circuit by flowing the solder to complete the interconnect. There are several different processes that can be used for flip-chip joining including processes that incorporate an underfill. In a number of embodiments, solder bumps alone or in combination with solder deposited on the connection pads of the external are used to connect the integrated circuit and the external circuit. In other embodiments, gold or gold/nickel bumps are used. Reflowing is typically achieved using an oven although in many embodiments thermocompression, or thermosonic joining can be used. Alternatively, adhesion can be achieved without reflow using an adhesive. When an underfill material is used, the underfill material can be applied by dispensing the underfill material along one or two sides of the chip from where the low viscosity epoxy is drawn by capillary action into the space between the chip and the MLCC. The underfill is then cured by heat. In many embodiments, the process of flip chip mounting the integrated circuit to the MLCC includes preparing the integrated circuit (often includes testing, and bumping of pads) and preparing the MLCC (application of flux or solder paste printing to the connection points of the MLCC). The bumps of the integrated circuit are then aligned to the contact points patterned onto the MLCC and placed on the MLCC. The bumps are then reflowed. Where flux is applied to the contact points on the MLCC, flux residue can be cleaned. If underfill is used, the underfill can be dispensed and then cured.

In several embodiments, the integrated circuit die mounted to the MLCC is protected using an encapsulant. A quick drying encapsulant that adheres to a ceramic substrate can be used such as a flexible UV light curing encapsulant. In a number of embodiments, an encapsulant in the DYMAX 9000 Series manufactured by Dymax Corporation of Torrington, Conn. is used to encapsulate and protect an integrated circuit die mounted to a MLCC in a transponder assembly in accordance with an embodiment of the invention. In other embodiments, any of a variety of encapsulants appropriate to the application can be used.

In many embodiments, the integrated circuit is a circuit suitable for use in an RFID transponder such as the integrated circuits used in transponders such as the RI-TRP-REHP manufactured by Texas Instruments, Inc. of Dallas, Tex. The integrated circuit includes a pair of terminals that are configured for connection to the capacitor and a pair of terminals that are configured for connection to an antenna, such as disclosed in U.S. Pat. No. 5,729,023, the disclosure of which is incorporated herein by reference in its entirety. The circuitry of the integrated circuit is capable of responding to RF activation signals received from a reader via an antenna. The response is determined by the nature of the application and whether the transponder is an FDX or an HDX transponder. In embodiments where the transponder is a low frequency HDX transponder, the integrated circuit stores current from the antenna in the MLCC and uses the current to generate a frequency shift keyed signal containing an identification code that is applied across the antenna terminals. In a number of embodiments, the circuitry is configured to store information and communicate with a reader in accordance with a standard such as ISO 11784 and 11785, the disclosure of which is incorporated by reference herein in its entirety.

The electrical connection points and conductive paths formed on the ceramic exterior of the MLCC as described above are illustrated in FIG. 4. In FIG. 4, connection points 402, 404 and conductive paths 405, 406 are visible on the surface of a MLCC 400 viewed from above. In this depiction, connection points 404 are used to connect with the contacts on an integrated circuit, and connection points 402 are used to connect to an antenna coil. MLCC terminations 401 connect to two of the integrated circuit connection points 404 by means of conductive paths 405. Antenna connection points 402 connect to two other integrated circuit connection points 404 by means of conductive paths 406. Connection points 402, 404 and conductive paths 405, 406 are applied to the ceramic substrate surface 403 of MLCC 400 by printing, screening, sputtering, vapor deposition, photolithography, or any other suitable method that can be used to form circuits on a ceramic substrate in electronic hybrid circuit fabrication and that is know to those of ordinary skill in the art.

FIGS. 5(a)-5(c) illustrate the transponder assembly shown in FIG. 3 viewed from above and viewed from two side perspectives. FIG. 5(a) shows the transponder assembly 300 from a front view, illustrating the integrated circuit's bumped electrical contacts 503 as the connection means between the circuit traces formed on the ceramic exterior of the MLCC 501 and the integrated circuit 502. The integrated circuit's bumped contacts 503 visible in FIG. 5(a) are electrically connected to the MLCC connection points (404 in FIG. 4) by soldering, using flip-chip mounting techniques. FIG. 5(b) shows the transponder assembly 300 as viewed from above and illustrating the integrated circuit 303 attached to the MLCC 301 and connection points 305 for the attachment of an antenna coil to the MLCC. FIG. 5(c) shows the transponder assembly 300 from a side view, which illustrates the integrated circuit's bumped electrical contacts 503 as the connection means between MLCC 301 and integrated circuit 303.

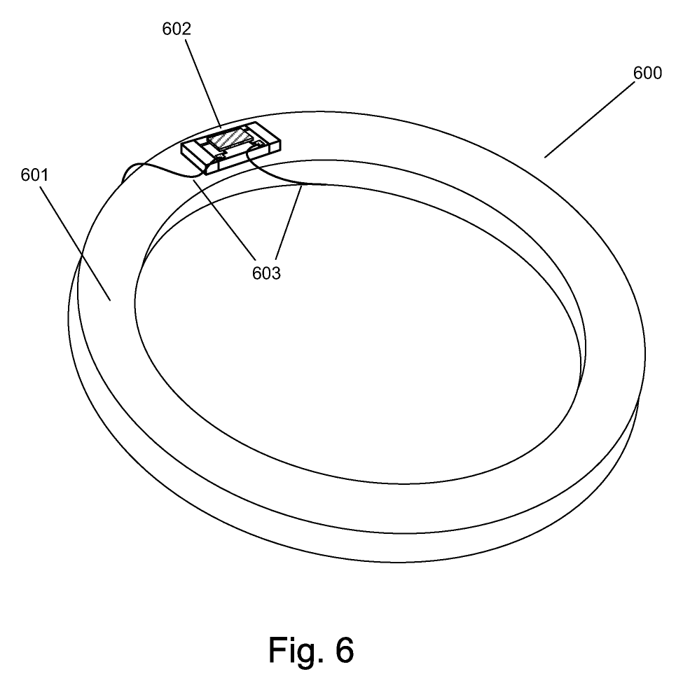

FIG. 6 illustrates the composite assembly 600 of an antenna coil 601 and a transponder assembly 602 in accordance with an embodiment of the invention. Antenna coil 601 comprises multiple turns of insulated copper wire that is wound with dimensions and specifications that are suitable to produce the desired electrical and physical characteristics required for the transponder application. The antenna coil 601 has two electrical connections 603 that are connected to the transponder assembly's 602 coil connection points (402 in FIG. 4). The transponder assembly 602 may be adhered to coil 601 or may be left suspended by antenna leads 603.

Composite assembly 600 can be embedded in a protective physical package of any type compatible with its end use. Assembly 600 can be over-molded with a polymeric material, or encased in a multi-piece preformed polymeric enclosure that is subsequently bonded together. In other embodiments, the antenna coil 600 can exist in other physical forms, such as printed or etched on a flat substrate such as mylar or fiberglass, or the antenna coil 600 can be wound on a ferrite core. Such alternate coil structures may lead to physical packages that comprise laminated polymeric sheets, or and glass or polymeric ampoules.

Other transponders that fall within the scope of the invention can be envisioned. For example, the conductive contacts and paths that have been disclosed as being deposited directly on the ceramic surface of the MLCC may alternately be deposited on an intermediate film substrate, such as Kevlar, and this intermediate substrate bonded to the MLCC, so as to provide the same purpose and function in the same manner as has been disclosed in the embodiment presented.

In the embodiment presented, the MLCC is described as being the charge capacitor that operates in conjunction with an HDX type transponder. In a similar manner, the MLCC could also be a resonant circuit capacitor used in conjunction with an FDX type transponder. Furthermore, in embodiments wherein the MLCC operates in conjunction with an HDX type integrated circuit, the MLCC could be modified to accommodate the mounting of a resonant circuit capacitor (an MLCC of smaller size, 0201 or 0402, for example) in addition to the HDX integrated circuit. Such a variation would include an additional set of connection points that allow the resonant capacitor to be connected in parallel with the antenna coil connection points.

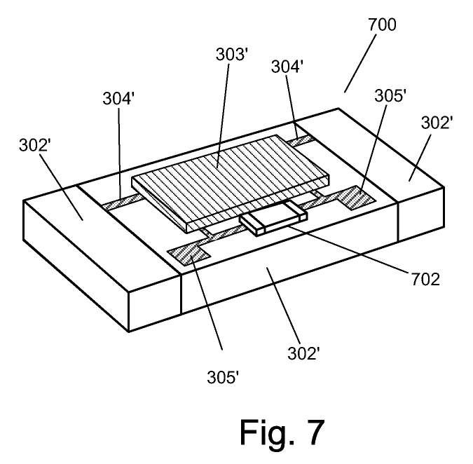

A transponder assembly including an MLCC on which an integrated circuit and a resonant circuit capacitor are mounted in accordance with an embodiment of the invention is illustrated in FIG. 7. The transponder assembly 700 includes an MLCC 700 including a ceramic surface on which circuit traces are formed. An integrated circuit 703 and a resonant capacitor 714 are mounted to the surface of the MLCC 701. Circuit traces 704 formed on the surface of the MLCC connect contacts on the integrated circuit to the MLCC terminals 702. Circuit traces formed on the surface of the MLCC also connect contacts on the integrated circuit to contact points 705, where an antenna can be connected. Additional circuit traces connect the resonant capacitor 714 in parallel with the contact points 705.

Although the present invention has been described in certain specific aspects, many additional modifications and variations would be apparent to those skilled in the art. It is therefore to be understood that the present invention may be practiced otherwise than specifically described, including various changes in the implementation such as utilizing encoders and decoders that support features beyond those specified within a particular standard with which they comply, without departing from the scope and spirit of the present invention. For example, the above reference discusses the mounting of integrated circuits using flip-chip mounting techniques however; other techniques suitable for mounting an integrated circuit to a ceramic surface can also be used. In addition, the processes described above can be adapted to mount other combinations of devices and/or in applications other than RFID. Furthermore, the illustrated embodiments show circuit traces formed on a single surface of the capacitor. In a number of embodiments, circuit traces and/or components are located on multiple surfaces of the capacitor. Additionally, MLCC manufacturing processes can be utilized to construct a two element capacitor including a charge capacitor and a tuning capacitor in a monolithic package. Thus, embodiments of the present invention should be considered in all respects as illustrative and not restrictive.

What is claimed is:

1. A transponder, comprising:
a capacitor having at least two terminals, where circuit traces are formed on at least one surface of the capacitor and connect to the terminals;
an integrated circuit mounted to a surface of the capacitor and including a plurality of contacts connected to the circuit traces formed on the capacitor; and
an antenna coil including two antenna leads that are connected at contact points to the circuit traces formed on the capacitor;
wherein the circuit traces connect at least two of the terminals of the capacitor to at least two of the contacts of the integrated circuit;
wherein the circuit traces connect the two antenna leads to at least two of the contacts of the integrated circuit; and
wherein the integrated circuit includes circuitry capable of generating an identification code signal in response to receipt of an activation signal by via the antenna coil.

2. The transponder of claim 1, wherein the capacitor includes a ceramic layer and the circuit traces are formed on the surface of the ceramic layer.

3. The transponder of claim 2, wherein the integrated circuit is mounted to the surface of the ceramic layer of the capacitor.

4. The transponder of claim 2, wherein the capacitor is a Multi-Layer Chip Capacitor.

5. The transponder of claim 1, wherein the circuitry of the integrated circuit includes an integrated resonant capacitor.

6. The transponder of claim 1, further comprising:
a resonant capacitor including two contacts mounted to the surface of said capacitor, where the terminals of the resonant capacitor are connected to the circuit traces formed on said capacitor;
wherein the circuit traces connect the resonant capacitor in parallel with the antenna leads.

7. The transponder of claim 1, wherein the circuit traces formed on at least one surface of the capacitor are patterns of electrically conductive material formed directly on the surface of the capacitor.

8. The transponder of claim 1, wherein the circuit traces formed on at least one surface of the capacitor further comprise an intermediate film substrate on which patterns of electrically conductive material are formed, where the intermediate film substrate is bonded to at least one surface of the capacitor.

9. The transponder of claim 1, wherein the contacts of the integrated circuit are bumped contacts.

10. The transponder of claim 1, further comprising an encapsulant that encapsulates the integrated circuit and bonds the integrated circuit to the capacitor.

11. The transponder of claim 1, wherein the capacitor is a two element capacitor that includes a charge capacitor having two terminals and a tuning capacitor having two terminals manufactured in a monolithic package.

12. A method of manufacturing a transponder assembly, comprising:
forming circuit traces on a ceramic surface of a capacitor;
aligning an integrated circuit including contacts with respect to the circuit traces formed on the ceramic surface; and
mounting the integrated circuit to the ceramic surface of the capacitor.

13. The method of claim 12, wherein the capacitor is a multi-layer chip capacitor and the circuits are screened onto the ceramic surface of the capacitor using thick film processing techniques.

14. The method of claim 13, wherein the integrated circuit is a die that includes contact pads that is prepared for mounting to the ceramic surface of the capacitor by bumping the contacts of the integrated circuit.

15. The method of claim 14, wherein mounting the integrated circuit further comprises reflowing the bumps on the contacts of the integrated circuit.

16. The method of claim 15, further comprising dispensing an underfill adjacent the integrated circuit and curing the underfill.

17. A method of manufacturing a transponder comprising:
forming circuit traces on a ceramic surface of a capacitor;
aligning an integrated circuit including contacts with respect to the circuit traces formed on the ceramic surface;
mounting the integrated circuit to the ceramic surface of the capacitor; and
connecting antenna leads at contact points to the circuit traces formed on the surface of the capacitor.

18. The method of claim 17, further comprising encapsulating the capacitor, the integrated circuit and the antenna.
